(19) United States
(12) Patent Application Publication
(10) Pub. No.: US 2007/0256940 A1
(43) Pub. Date: Nov. 8, 2007

(54) Device and Method for Removing Foreign Matter from Process Solutions

(76) Inventors: Alexander Schiffer, Hemer (DE); Reinhard Schwarz, Amberg (DE)

Correspondence Address: WILLIAM COLLARD;COLLARD & ROE, P.C., 1077 NORTHERN BOULEVARD, ROSLYN, NY, 11576, US

(21) Appl. No.: 11/659,589

(22) PCT Filed: Aug. 8, 2005
(86) PCT No.: PCT/EP05/08570

§ 371 Date: Feb. 7, 2007

(30) Foreign Application Priority Data
Aug. 10, 2004 (DE) 10 2004 038 693.5

(51) Int. Cl. C02F 1/461; B01D 17/06; B01D 35/06

(52) U.S. Cl. 205/765; 204/665; 205/759

(57) ABSTRACT

The invention relates to a device for removing foreign matter from process solutions. Said device comprises an electrolytic system having at least one cell divided up by at least two current-carrying dividing walls which define at least one connecting chamber, and at least one anode and one cathode compartment. An auxiliary cycle (51) is guided through the connecting compartment (5), a cation exchanger (8) being disposed therein. The invention also relates to a method for removing foreign matter form process solutions, whereby the process solution (1*) is supplied to an anode compartment (2) of an inventive device, a voltage is supplied to the electrodes (3, 9) of the electrolytic system, solution is taken from the at least one connecting compartment (5) and is applied to a strongly acid H⁺ cation exchanger (8) and the solution running off from the cation exchanger is supplied to at least one connecting compartment (5). The invention also relates to a method for regenerating a cation exchanger whereby first cations bound by the cation exchanger (8) are removed by treatment with anionic complexing agents and the cation exchanger (8) is then readjusted to the H⁺ charged state by adding a regenerant acid.

The invention relates to a device for removing foreign substances from process solutions, in accordance with the preamble of claims 1, 7, and 9.

In the case of surface finishing of metallic materials, entrainment of foreign substances takes place by means of etching processes, thereby limiting the period of use of the process solutions in question. As soon as the concentration of foreign substances has exceeded a limit value, the process solution must be rejected, in whole or in part, and treated in terms of waste water technology, since the increasing concentration of foreign substances leads to unsatisfactory coating results. In order to put the process solution back into a functional state, (partial) rejection of the process solution generally takes place, in order to circulate the foreign substances out, and the process solution is supplemented with appropriate added substances, to equalize the losses of material.

In order to minimize the rejection of acidic process solutions by means of a targeted separation of foreign substances, or to actually avoid it entirely, various methods are known for purifying them, but these have not proven themselves in operational practice.

From DE 32 07 776 A1, an electrolysis system having a divided cell is known for electrodialytic purification of galvanizing solutions, in which the separation is supposed to take place between the anode space and cathode space, by means of a cation exchanger membrane. The solution to be purified is introduced into the anode space, while an alkaline solution of alkali or ammonium hydroxide, carbonate, and/or hydrogen carbonate is used in the cathode space. By means of applying an electrical field, the multivalent cations are supposed to be transported out of the anolyte into the catholyte, and precipitated there as hydroxides or carbonates, because of the pH that has been set. In practice, however, it has turned out that the transport of multivalent cations through a cation exchanger membrane in acidic solutions, in other words in the presence of higher proton concentrations, is clearly inhibited, since protons possess a significantly greater mobility and therefore can pass through the cation exchanger membrane more easily than the multivalent cations. Therefore high tensions are required at the electrodes of the electrolysis cell, in order to transport the multivalent cations out of the anolyte into the catholyte. This requires a high expenditure of energy, which has a negative effect on the economic efficiency of this method. Furthermore, all of the cation exchanger membranes that are technically available are sensitive to concentrated acidic media, particularly if these contain oxidizing components such as dichromates, for example, since concentrated media can damage the membranes osmotically. Therefore at most dilute solutions can be treated with the system configuration described, at great expenditure of energy, because the purified solutions must be brought back to their initial concentration after purification has taken place, by means of suitable concentration methods, such as evaporation, for example. Because of the poor economic efficiency of electrodialytic purification, the high expenditure of energy required, as well as the insufficient stability of the membranes used with regard to concentration process solutions, the known method is not suitable for operational practice.

From DE 44 08 337 C2, a two-chamber electrolysis system for electrodialytic purification of acidic process solutions is known, in which the separation between anode and cathode space is supposed to take place by means of a plastic diaphragm, which has sufficient stability with regard to concentrated process solutions. The solution to be purified is introduced into an anode space of the electrolysis cell. By means of applying an electrical field, the foreign metal ions are supposed to be transported into the cathode space of the diaphragm electrolysis system, by means of electrodialysis, in that the foreign metal ions are precipitated as hydroxides by adding a base, and removed by means of filtration. In operational practice, however, it has been shown that the acidic components of the process solution are transported into the catholyte significantly more quickly than the foreign metals. Furthermore, great amounts of base are required to adjust the pH in the catholyte. Because of the added base and the diffusion of component substances from the catholyte into the process solution in the anode space, contamination of the process solution to be purified with disruptive foreign substances takes place. The foreign metal hydroxides that are precipitated out additionally cause blocking of the porous plastic diaphragms that are used, so that the purification system is no longer functional after only a short period of time. In addition, contamination of the process solution with alkali metal ions also impairs the functional capacity of the process solution to be purified. Even the additional use of pulsed direct current described in DE 198 12 005 A1 cannot eliminate the deficits described.

In DE 43 15 411 C2, an electrolysis system having a divided cell is proposed for regenerating used chromic acid solutions, in which system the separation of anode and cathode space takes place by means of a cation exchanger membrane, whereby the catholyte is passed over a highly acidic cation exchanger, which was previously regenerated with acid and thereby converted to the H⁺ charge. In this connection, a partial stream of a process solution that can no longer be used is supposed to be utilized, whereby the Cr(VI) contained in this partial stream is reduced to Cr(III) and very strongly bound by the highly acidic cation exchanger. According to the known selectivity of highly acidic cation exchangers, Cr³⁺ ions can displace almost all other cations from this cation exchanger material. Because of the great affinity of Cr³⁺ ions, the regeneration of the cation exchanger material is therefore difficult. Therefore, for removing the Cr³⁺ ions from the cation exchanger resin, the use of a 15% hydrochloric acid is proposed. Since even traces of chloride in a process solution can lead to very great problems for galvanic chrome deposition, it is indicated that the cation exchanger resin must be washed free of chloride, which requires a very great expenditure of rinsing water and can therefore be carried out only with significant expenditure. As explained above, the transport of multivalent cations through a cation exchanger membrane is clearly inhibited in acidic solutions, and for this reason, significant voltages must be applied to the electrodes of the electrolysis cell for the transport of multivalent cations. Furthermore, the technically available cation exchanger membranes have only a limited resistance to concentrated chromic acid media.

In addition, there is another specific set of problems: Multivalent cations such as Al³⁺, Fe³⁺, and Cr³⁺ are very strongly bound by a highly acidic cation exchanger. They can be removed from the cation exchanger material again only by means of special treatment. In the case of Cr³⁺, it is possible to utilize its good oxidizability in the alkaline range for this purpose. By means of treatment with caustic soda and 30% hydrogen peroxide, one achieves the result that the Cr³⁺ cation is converted to the chromate (CrO₄²⁻) anion. Since chromate is not bound by the cation exchanger material, one can achieve complete removal of the Cr³⁺ from the cation exchanger material in this manner. After oxidative special treatment with caustic soda and 30% hydrogen peroxide, the cation exchanger material is situated in the Na charge and can be converted back to the H⁺ charge by means of the use of a regeneration acid, whereby the use of sulfuric acid also leads to good regeneration results. Therefore the use of hydrochloric acid as a regeneration acid can be refrained from, if necessary. This is particularly relevant for certain process solutions (galvanic chrome deposition, anodizing of aluminum, etc.), since here, chlorides cause great disruptions in the coating processes and therefore the use of hydrochloric acid as a regeneration acid is precluded.

The removal of Fe³⁺ is more problematic. When using hydrochloric acid as a regeneration acid, an anionic chloro-complex forms in the case of Fe³⁺ at high chloride concentrations, so that Fe³⁺ ions can be removed from a highly acidic cation exchanger material without major problems. If the use of hydrochloric acid is not possible for reasons of process technology, the removal of Fe³⁺ is currently connected with a significant expenditure of chemicals and water.

For the removal of Al³⁺ from the highly acidic cation exchanger material, no appropriate pre-treatment step is currently known, so that removal of these ions is only possible with significant expenditure of chemicals and water.

Since the previously known methods have proven not to be usable in practice, because of the problems discussed, the state of the art is characterized by the rejection of process solutions that can no longer be used, by waste water technology treatment of this partial stream, and by equalization of the substance losses by means of the use of fresh chemicals. This results in high costs and high environmental burdens, since the residues of waste water technology treatment generally have to be disposed of as hazardous waste containing heavy metals.

This is where the invention wants to provide a remedy. The invention is based on the task of creating a device for removing foreign substances from process solutions, which allows economically reasonable and practically useful removal of the entrained foreign substances from the process solution, particularly for the treatment of metal surfaces. According to the invention, this task is accomplished in that an auxiliary circuit is passed through the connection space, in which circuit a cation exchanger is disposed.

With the invention, a device for removing foreign substances from process solutions is created, which allows economically reasonable and practically useful removal of the entrained foreign substances from the process solution, particularly for the treatment of metal surfaces.

Preferably, at least one of the partitions is a porous diaphragm or a cation exchanger membrane. By means of the use of a porous diaphragm or an appropriate cation exchanger membrane, foreign substances can be transferred from the concentrated process solution into the auxiliary circuit, from which the foreign substances can be removed selectively and with great efficiency, by means of suitable ion exchanger materials. In the auxiliary circuit, the concentrations of the components involved can be adjusted by means of suitable selection of the material and the pore width of the diaphragm used, as well as by way of the voltage applied to the electrodes, in such a manner that the removal of the foreign substances takes place at high efficiency and, at the same time, the sensitive components of the purification device are not damaged.

The cell configuration of the multi-chamber electrolysis system, according to the invention, allows not only the transport of the foreign substances but also the electrodialytic return transport of component substances of the process solution, which were diffused into the auxiliary circuit during the course of the purification process. Both processes have the result that the foreign substances are removed from the process solution, and the component substances required for the surface treatment process are transported back into the process solution. The purified process solution can thereby continue to be utilized for the surface treatment process, whereby the purification method and the device according to the invention can be used for removing metallic foreign substances from a plurality of process solutions, preferably acidic ones. In contrast to the previously known methods, a device combination of membrane electrolysis and ion exchange is used in this connection, whereby a three-chamber cell is used in the case of membrane electrolysis. By means of shielding the cathode space by means of a cation exchanger membrane, an undesirable reduction of chromate at the cathode is avoided, for example, in the case of the purification of solutions that contain chromic acid. In addition, it is possible to refrain from the addition of problematic substances, by means of which contamination of the process solution could possibly take place.

In a further development of the invention, at least one of the partitions is a porous diaphragm or a cation exchanger membrane. In this way, separation between anode and cathode space is achieved, with simultaneous permeability for foreign substances.

Preferably, the anode is equipped with diaphragms on both sides, in each instance, and the cathode is equipped with cation exchanger membranes on both sides, in each instance. Separation of the anolyte and the catholyte, respectively, from the solution of the auxiliary circuit is achieved in this way. Furthermore, membrane electrode units can be formed, which can be added to or removed from the cells in pairs, depending on the amount of foreign substance.

In an embodiment of the invention, the cation exchanger is connected with distribution pipes having a tuyere system on the run-off side, which pipes are disposed on the cell. In this way, a uniform concentration distribution of the component substances in the auxiliary circuit in the electrolysis tub is achieved.

In another embodiment of the invention, at least one pump is provided to supply anolyte and/or catholyte, which pump is connected with a tuyere system. In this way, uniform mixing is achieved.

The invention is furthermore based on the task of creating a method for removing foreign substances from process solutions, which allows economically reasonable and practically useful removal of the entrained foreign substances from process solutions, particularly for the treatment of metal surfaces. According to the invention, this task is accomplished in that the process solution is passed to an anode space of an embodiment of the device according to the invention, an electrical voltage is applied at the electrodes of the electrolysis system, solution is removed from at least one connection space and applied to a highly acidic cation exchanger in the H⁺ charge, and the solution running off from the cation exchanger is passed back to at least one connection space.

With the invention, a method for removing foreign substances from process solutions is created, which allows economically reasonable and practically useful removal of the entrained foreign substances from process solutions, particularly for the treatment of metal surfaces.

In an embodiment of the invention, the solution that runs off from the cation exchanger is distributed in at least one connection space by way of distributor pipes having a tuyere system. In this way, good mixing of the solution of the auxiliary circuit is achieved.

The invention is furthermore based on the task of creating a method for regenerating a cation exchanger, particularly for removing foreign substances from process solutions, which allows efficient and economically reasonable removal of the entrained foreign substances from a process solution, particularly for the treatment of metal surfaces. According to the invention, this task is accomplished in that first, cations bound by the cation exchanger are removed by means of treatment with anionic complex forming agents, and subsequently, the cation exchanger is converted back to the H⁺ charge by means of applying a regeneration acid.

With the invention, a method for regenerating a cation exchanger, particularly for removing foreign substances from process solutions, is created, which allows efficient and economically reasonable removal of the entrained foreign substances from a process solution, particularly for the treatment of metal surfaces.

In an embodiment of the invention, fluoride as an anionic ligand is used as the complex forming agent. When using fluoride as an anionic ligand in connection with waste water technology treatment of the corresponding partial streams with milk of lime, the desired regeneration effect can be achieved, and additional expenditure in waste water technology treatment can be avoided, since fluoride forms stable fluoride complex anions with Al³⁺ or Fe³⁺, on the one hand, but on the other hand, the fluoride ions are precipitated as calcium fluoride in the course of the waste water technology treatment with milk of lime, and thereby removed from the waste water partial stream.

Preferably, the fluoride is alkali metal or ammonium fluoride, preferably sodium fluoride. By means of the pre-treatment of a charged exchanger with an alkali metal or ammonium fluoride, preferably sodium fluoride, the former is first converted to the corresponding alkali metal or ammonium charge, and can be converted back to the H⁺ charge by means of the use of a regeneration acid, whereby the use of sulfuric acid also leads to good regeneration results. Thus, if necessary, it is possible to do without the use of hydrochloric acid as a regeneration acid, particularly in the case of process solutions (galvanic chrome deposition, anodizing of aluminum, etc.) in which chlorides cause great disruptions in the coating processes and therefore the use of hydrochloric acid as a regeneration acid is precluded.

By means of the two-stage regeneration process according to the invention, good removal of the multivalent cations from the highly acidic cation exchanger material can be achieved, so that the total capacity of the highly acidic cation exchanger material can continue to be utilized for purification of the process solution.

Other further developments and embodiments of the invention are indicated in the other dependent claims. An exemplary embodiment of the invention is shown in the drawing and will be explained in detail below. The drawing shows:

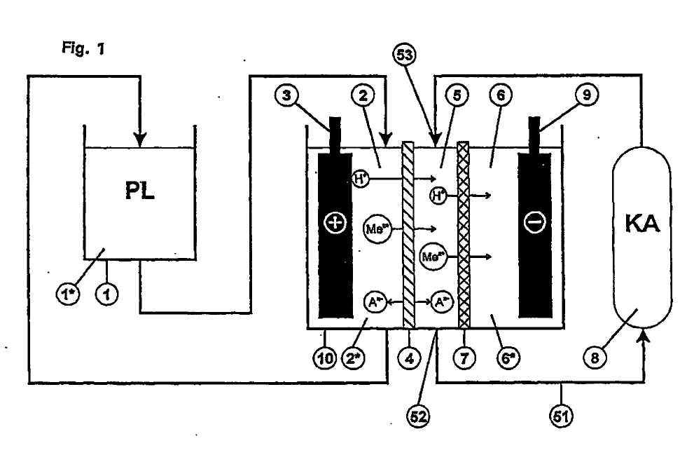

FIG. 1 a schematic representation of the purification method, using the device according to the invention, and

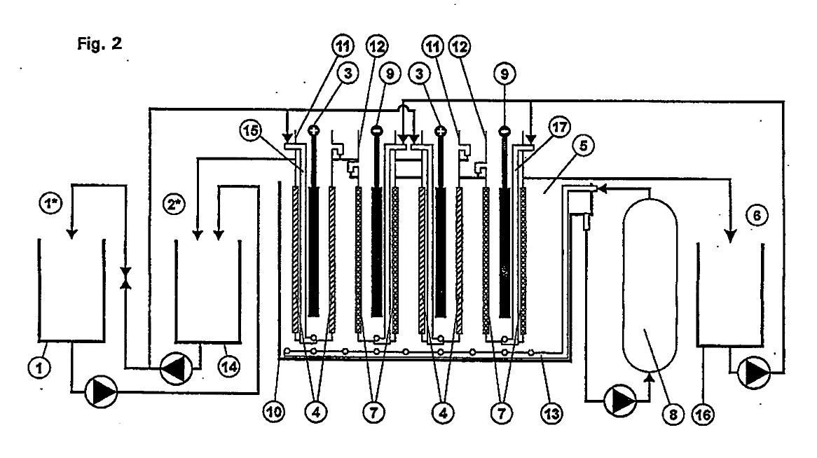

FIG. 2 a schematic representation of the device for removing foreign substances from process solutions.

The device for removing foreign substances from process solutions chosen as the exemplary embodiment, according to FIG. 1, consists essentially of an electrolysis cell 10, in which an anode 3 and a cathode 9 are disposed lying opposite one another. Between anode 3 and cathode 9, a diaphragm 4 on the anode side and a cation exchanger membrane 7 on the cathode side are provided, parallel to one another, so that three spaces are formed: an anode space 2 on the anode side, a cathode space 6 on the cathode side, and a connection space 5 formed between diaphragm 4 and cation exchanger membrane 7. The connection space 5 contains an auxiliary circuit 51, in which a cation exchanger 8 is disposed.

The process solution 1*, which is supposed to be purified of cationic contaminants, is passed to the anode space 2 of the purification device. The auxiliary circuit contains a dilute process solution, since part of the component substances of the process solution can diffuse from the anolyte 2* into the auxiliary circuit 51, through the diaphragm. By applying an electrical voltage to the electrodes 3, 9 in the electrolysis cell 10, an electrical field is established, by means of which an electrodialytic transport of ions is brought about. The cation exchanger connected between run-out 52 and run-off 53 of the connection space 5 is highly acidic and is in the H⁺ charge.

The transport of protons (H⁺) and other cations (Me²⁺) as well as the related anions (A^{x-}) from the anode space 2 through the diaphragm 4 into the connection space 5 takes place by dialysis, as a result of the different concentrations of the components in the anode space 2 and in the auxiliary circuit 51, in each instance. In addition, the protons (H⁺) and other cations (Me²⁺) are also transferred from the anode space 2 into the auxiliary circuit 51 by means of electrodialysis, while the anions (A^{x-}) are transported back to the anode space 2 from the auxiliary circuit 51, by means of electrodialysis. In this way, the cationic contaminants are transferred from the anode space 2 into the auxiliary circuit 51.

The solution of the auxiliary circuit 51 is removed from the chamber 5 and applied to the highly acidic cation exchanger 8, which is in the H⁺ charge. In this way, multivalent cations are bound to the cation exchanger material, and thereby removed from the auxiliary circuit 51. At the same time, an equivalent amount of protons is released by the cation exchanger material, and placed into the solution of the auxiliary circuit 51. The solution that runs off from the cation exchanger 8 is transported back to the connection space 5, thereby achieving good mixing in this space 5, at the same time. In this way, the concentration of the multivalent cations in the auxiliary circuit 51 levels off at a low level.

The protons (H⁺) and other cations (Me²⁺) can be transported out of the auxiliary circuit 51 into the cathode chamber 8 through the cation exchanger membrane 7, whereby the transport of the protons (H⁺) takes place with preference, since protons possess greater mobility and in addition, the concentration of the multivalent cations is reduced by means of the treatment of the solution of the auxiliary circuit 51 with the highly acidic cation exchanger material of the cation exchanger 8, and the concentration of the protons in the auxiliary circuit 51 is raised.

The membrane area of the purification device must be adapted to the introduction of foreign substances, whereby the required membrane area can be achieved by means of a multiple arrangement of the spaces 2, 5, 6 shown in FIG. 1.

In FIG. 2, a device for removing foreign substances by means of a method combination of membrane electrolysis and ion exchange, for use in operational practice, is shown, whereby in this exemplary embodiment, two anode elements 11 and two cathode elements 12 are provided, in each instance. Depending on the amount of foreign substances to be removed, membrane electrode units 11, 12 can be added to or removed from a sufficiently dimensioned electrolysis cell 10, in pairs. When replacing a membrane 4, 7, only the membrane electrode unit in question has to be shut down and taken out of the electrolysis cell 10. The remainder of the system remains functional.

The purification device according to FIG. 2 consists essentially of a cell in the form of an electrolysis tub 10, which is made from plastic or rubberized steel, and in which the solution of the auxiliary circuit 51 is situated. The solution of the auxiliary circuit 51 is removed from the electrolysis tub 10 by way of a pump, and applied to a highly acidic cation exchanger 8 in the H⁺ charge, which is situated in an ion exchanger column. The solution of the auxiliary circuit 51 that runs off from the cation exchanger 8 is distributed in the electrolysis tub 10 by way of distribution pipes having a tuyere system 13. In this way, a uniform concentration distribution of the component substances in the auxiliary circuit 51 is achieved in the electrolysis tub 10.

The anodes 3 are situated in membrane electrode units 11 that are equipped with diaphragms 4 on both sides. In this way, a separation of the anolyte 2* from the solution of the auxiliary circuit 5 is achieved. The anolyte 2* is transported into the membrane electrode units 11, from a supply vessel 14, by way of distribution pipes having a tuyere system 15, by way of a pump, and runs back into the supply vessel 11 by way of a collector line, without pressure. Good mixing is assured by means of distribution pipes having a tuyere system 13 at the bottom of the membrane electrode unit.

The cathodes 9 are situated in membrane electrode units 12 that are equipped with cation exchanger membranes 7 on both sides. In this way, a separation of the catholyte 6* from the solution of the auxiliary circuit 51 is achieved. The catholyte 6* is transported into the membrane electrode units 12, from a supply vessel 16, by way of distribution pipes having a tuyere system 17, by way of a pump, and runs back into the supply vessel of the catholyte by way of a collector line, without pressure. Good mixing is assured by means of the tuyere system at the bottom of the membrane electrode unit 12.

The purified process solution 1* is transported back into the process tub 1 as needed, while at the same time, the process solution to be purified is removed from the process tub 1 and transported into the supply container 14 of the anolyte 2*. This allows continuous purification of the coating bath, since the purification device is operated as a secondary connection to the process tub 1.

The possibilities of use of the device and of the method for removing foreign substances from process solutions will be explained using the application examples listed below:

### EXAMPLE 1

### Process Solution for Chrome Plating, which Contains Cationic Contaminants such as Sodium, Iron, Aluminum, or Cr(III)

In the case of galvanic deposition of chrome from a chromic acid solution, entrainment of foreign metals into the process solution takes place by means of etching and/or de-metallization processes, limiting the useful lifetime of the solution. The type of entrained foreign substances is dependent on the basic material of the parts to be coated. Therefore, iron is essentially entrained into the process solution in the case of so-called hard chrome plating of steel work pieces.

By means of the use of the regeneration method according to the invention, the major part of the Cr(III) contained in the process solution is oxidized to dichromate (Cr₂O₇²⁻) in the acidic solution, at the anode. The remaining cationic foreign substances (Cr(III) ions, cations from the base material, sodium ions) are transported into the auxiliary circuit 51 from the anode space 2, through a porous diaphragm 4, by means of dialysis and electrodialysis. Due to the continuous application of the solution of the auxiliary circuit 51 to a highly acidic cation exchanger 8 in the H⁺ charge, these foreign substances are removed from the auxiliary circuit 51 again. In this connection, an equivalent amount of protons is released by the cation exchanger 8.

The cations migrate through a cation exchanger membrane 7 into the cathode space 6, whereby the protons are transported with preference, because of their greater mobility. The anions that diffuse into the auxiliary circuit 51 are prevented from migrating further in the direction of the cathode 9, and therefore kept away from it, by the cation exchanger membrane 7, thereby avoiding a reduction of chromate (CrO₄²⁻) or dichromate (Cr₂O₇²⁻), respectively, to Cr(III), for example. The anions are transported back into the anolyte 2* by means of electrodialysis, so that they can be used for the coating process once again.

For purification of a process solution for hard chrome plating contaminated with iron ions, a device according to the invention, having a membrane area of a total of 9 dm², is used. Removal of the cationic foreign substances takes place by means of a highly acid cation exchanger 8 in the H⁺ charge. Charging of the ion exchanger column, which is filled with 15 L of highly acidic cation exchanger material, takes place in an upward stream at an application speed of 10 m/h. The anode space 2 is equipped with lead anodes having a surface area of 10.2 dm², while electrodes made of stainless steel, having a surface area of 8.4 dm², are used in the cathode space 6. The cathode space 6 is filled with an approximately 5% H₂SO₄ solution.

The device is operated with an anodic current density of 300 A/m², for which purpose a voltage of 4.7 V is applied to the electrodes. To purify a contaminated process solution, the device is operated over a time period of 20 hours. During this time, the iron content in 25 L solution can be reduced from 8.4 g/L to 2.0 g/L. At the same time, anodic oxidation of Cr(III) also takes place, so that at the end of purification concentration, the content of Cr(III) lies below 0.1 g/L.

The purified process solution can subsequently be used for hard chrome plating again. In operational practice, it is advantageous to operate the device according to the invention parallel to the process solution, in order to be able to achieve uniform operating conditions by way of the regular removal of foreign substances.

The highly acidic cation exchanger material used in the ion exchanger column is washed with softened water or fully desalinated water after the purification process, and subsequently treated with a sodium fluoride solution (approximately 30 g/L), in order to convert the Fe(III) bound by the exchanger into the corresponding complex anion ([FeF₆]³⁻). Since Cr(III) is only incompletely removed from the highly acidic cation exchanger material by treating it with H₂SO₄, treatment with caustic soda and hydrogen peroxide takes place in addition, after several charging processes. In this way, extensive removal of Cr(III), in the form of chromate, from the cation exchanger material can be achieved.

By means of the subsequent treatment with H₂SO₄ (approximately 100 g/L), the highly acidic cation exchanger material is converted back to the H⁺ charge. The final washing process takes place with fully desalinated water (demineralized water), so that a prior charge of the highly acidic cation exchanger material with Na⁺ ions or other water component substances is avoided. The eluates of the highly acidic cation exchanger are treated in terms of waste water technology.

### EXAMPLE 2

### Anodizing Aluminum when Using a Process Solution that Contains H₂SO₄

When anodizing aluminum in a process solution that contains H₂SO₄ (approximately 200 g/L H₂SO₄), an etching attack on the surface also takes place, parallel to the anodic oxidation of the aluminum surface, whereby an aluminum entrainment of approximately 8 to 10 g/m² takes place, as a function of the surface of the work piece being treated. Above an aluminum concentration of approximately 20 g/L, the current yield of the anodic oxidation in the process solution containing H₂SO₄ drops, and the required coating properties are no longer achieved. To extend the useful lifetime of the process solution, it is necessary to remove the entrained aluminum.

In the case of the method according to the invention, reformation of the bound acid also takes place by means of the anodic decomposition of water. The aluminum ions are transported from the anode chamber 2, through a porous diaphragm 4, into the auxiliary circuit 51, by means of dialysis and electrodialysis, whereby there, the H₂SO₄ concentration is not allowed to exceed a value of 30 g/L, since otherwise, the highly acidic cation exchanger 8 is partially discharged again, and therefore the efficiency of the method drops.

The cations migrate through a cation exchanger membrane 7 into the cathode chamber 6, whereby the protons are transported with preference, because of their greater mobility. The anions that diffuse into the auxiliary circuit are transported back into the anolyte 2* by means of electrodialysis, so that they can be utilized for the surface treatment process once again.

In order to purify a process solution for anodizing aluminum surfaces contaminated with aluminum ions, a device according to the invention, having a membrane area of a total of 9 dm², is used. The removal of the cationic foreign substances from the auxiliary circuit takes place by means of a highly acidic cation exchanger in the H⁺ charge. Charging of the ion exchanger column, which is filled with 15 L of highly acidic cation exchanger material, takes place in an upward stream with an application speed of 10 m/h. Platinum-plated titanium stretched metal having a clear surface area of 6.1 dm² is used as the anodes 3, while electrodes 9 made of stainless steel, having a surface area of 8.4 dm² are used in the cathode space 6. The cathode space 6 is filled with an approximately 5% H₂SO₄ solution.

If the purification device is operated over a period of 20 hours for purifying a contaminated process solution, an aluminum amount of 150 g can be removed from 25 L of solution during this time.

The highly acidic cation exchanger material used in the ion exchanger column is washed with softened water or fully desalinated water after the purification process, and subsequently treated with a sodium fluoride solution (approximately 30 g/L), in order to convert the aluminum ions bound by the exchanger into the corresponding complex anion ([AlFe]³⁻). By means of the subsequent treatment with H₂SO₄ (approximately 100 g/L), the highly acidic cation exchanger material is converted back to the H⁺ charge. The final washing process takes place with demineralized water, so that a prior charge of the highly acidic cation exchanger material with Na⁺ ions or other water component substances is avoided. The eluates of the highly acidic cation exchanger are treated in terms of waste water technology.

### EXAMPLE 3

### Anodizing Aluminum when Using a Process Solution that Contains H₂CrO₄

When anodizing aluminum in a process solution that contains chromic acid, an etching attack on the surface also takes place, parallel to anodic oxidation of the aluminum surface, causing aluminum entrainment to take place. Removal of the entrained aluminum is necessary in order to extend the useful lifetime of the process solution.

In the case of the method according to the invention, back formation of the bound acid and oxidation of Cr(III) ions that have formed take place due to the anodic decomposition of water. The aluminum ions are transported out of the anode chamber 2 into the auxiliary circuit 51 through a porous diaphragm 4, whereby there, the H₂SO₄ concentration is not allowed to exceed a value of 30 g/L, since otherwise, the highly acidic cation exchanger 8 is partially discharged again, and therefore does not possess sufficient efficiency, in total.

The cations migrate through a cation exchanger membrane 7 into the cathode chamber 6, whereby the protons are transported with preference, because of their greater mobility. The anions that diffuse into the auxiliary circuit are prevented from migrating further in the direction of the cathode 9, and thereby kept away from the latter, by the cation exchanger membrane 7, thereby avoiding a reduction of chromate (CrO₄²⁻) or dichromate (Cr₂O₇²⁻), respectively, to Cr(III), for example. The anions are transported back into the anolyte 2* by means of electrodialysis, so that they can be used for the coating process once again.

For purification of a process solution for anodizing aluminum according to the Bengough method, contaminated with aluminum ions, a device according to the invention, having a membrane surface area of a total of 9 dm² is used. Removal of the cationic foreign substances from the auxiliary circuit takes place by means of a highly acidic cation exchanger 8 in the H⁺ charge. Charging of the ion exchanger column, which is filled with 15 L of highly acidic cation exchanger material, takes place in an upward stream at an application speed of 10 m/h. Electrodes having a platinum-plated titanium stretched metal having a clear surface area of 6.1 dm² are used as the anode 3, while electrodes 9 made of stainless steel, having a surface area of 8.4 dm², are used in the cathode space 6. The cathode space 6 is filled with an approximately 5% H₂SO₄ solution.

If the purification device is operated over a period of 20 hours for purifying a contaminated process solution, an aluminum amount of 120 g can be removed from the contaminated process solution during this time.

The highly acidic cation exchanger material used in the auxiliary circuit is washed with softened water or fully desalinated water after the purification process, and subsequently treated with a sodium fluoride solution (approximately 30 g/L), in order to convert the aluminum ions bound by the exchanger 8 into the corresponding complex anion ([AlFe]³⁻). Since Cr(III) which gets into the auxiliary circuit to a slight extent, is only incompletely removed from the highly acidic cation exchanger material by treating it with H₂SO₄, treatment with caustic soda and hydrogen peroxide takes place in addition, after several charging processes. In this way, extensive removal of Cr(III), in the form of chromate, from the cation exchanger material can be achieved. By means of the subsequent treatment with H₂SO₄ (approximately 100 g/L), the highly acidic cation exchanger material is converted back to the H⁺ charge. The final washing process takes place with demineralized water, so that a prior charge of the highly acidic cation exchanger material with Na⁺ ions or other water component substances is avoided. The eluates of the highly acidic cation exchanger are treated in terms of waste water technology.

1. Device for removing foreign substances from process solutions, containing an electrolysis system having a cell divided by at least two semi-permeable partitions, by means of which at least one connection space is formed, having at least one anode space and one cathode space, wherein an auxiliary circuit (51) is passed through the connection space (5), in which circuit a cation exchanger (8) is disposed.

2. Device according to claim 1, wherein at least one of the partitions (4, 7) is a porous diaphragm or a cation exchanger membrane.

3. Device according to claim 1, wherein a semi-permeable partition (4, 7) is disposed on both sides of at least one anode (3) and one cathode (9).

4. Device according to claim 3, wherein the anode (3) is equipped with diaphragms (4) on both sides, and the cathode (9) is equipped with cation exchanger membranes (7) on both sides, in each instance.

5. Device according to claim 1, wherein the cation exchanger (8) is connected with distribution pipes having a tuyere system (13) on the run-off side, which pipes are disposed on the cell (1).

6. Device according to claim 1, wherein at least one pump is provided for the anolyte and/or catholyte supply, which pump is connected with a tuyere system (13).

7. Method for removing foreign substances from process solutions, wherein the process solution (1*) is passed to an anode space (2) of a device according to claim 1, an electrical voltage is applied at the electrodes (3, 9) of the electrolysis system, solution is removed from at least one connection space (5) and applied to a highly acidic cation exchanger (8) in the H⁺ charge, and the solution running off from the cation exchanger (8) is passed back to at least one connection space (5).

8. Method according to claim 7, wherein the solution that runs off from the cation exchanger (8) is distributed in at least one connection space (5) by way of distribution pipes having a tuyere system (13).

9. Method for regenerating a cation exchanger, wherein first, cations bound by the cation exchanger (8) are removed by means of treatment with anionic complex forming agents, and subsequently, the cation exchanger (8) is converted back to the H⁺ charge by means of applying a regeneration acid.

10. Method according to claim 9, wherein flouride as an anionic ligand is used as the complex forming agent.

11. Method according to claim 10, wherein the flouride is alkali metal or ammonium flouride, preferably sodium flouride.

12. Method according to claim 10, wherein the waste water partial streams resulting from the treatment are treated with milk of lime.
